(19) United States
(12) Patent Application Publication
(10) Pub. No.: US 2008/0253938 A1
(43) Pub. Date: Oct. 16, 2008

(54) Method and apparatus for vaporizing fuel in a hydrocarbon reformer assembly

(76) Inventor: Bernhard A. Fischer, Greer, SC (US)

Correspondence Address: Paul L. Marshall, Esq.;Delphi Technologies, Inc., Mail Code 480410202, P.O. Box 5052, Troy, MI, 48007, US

(21) Appl. No.: 11/787,123

(22) Filed: Apr. 13, 2007

(51) Int. Cl. B01D 53/34

(52) U.S. Cl. 422/168

(57) ABSTRACT

A catalytic reformer assembly including a liquid hydrocarbon fuel vaporizer comprising a combustion zone and a mixing zone ahead of the reformer. Fuel flow is divided between a principal flow directed to the mixing zone and a secondary flow directed to the combustion zone. Air flow is also divided between a principal flow to the mixing zone and a secondary flow to the combustor. The principal air flow is mixed with the combustor effluent together with anode tailgas recycle (“recycle”) when it becomes available. The flow of recycle is also divided into principal and secondary flows. By varying component flows, the mixture temperature can be controlled. The principal fuel flow is injected into the hot mixture of combustion products, air, and recycle in the mixing zone.

### TECHNICAL FIELD

The present invention relates to a catalytic hydrocarbon reformer assembly for converting a hydrocarbon stream to a gaseous reformate fuel stream comprising hydrogen; and more particularly, to a fast light-off catalytic reformer assembly; and most particularly to a method and apparatus for rapid vaporization of liquid hydrocarbon fuel. The present invention is useful for rapidly and efficiently providing reformate without coking of the vaporizer or the reformer catalyst bed.

### BACKGROUND OF THE INVENTION

A catalytic hydrocarbon fuel reformer converts a hydrocarbon fuel stream into a hydrogen-rich reformate fuel stream comprising a gaseous blend of hydrogen, carbon monoxide, and nitrogen (ignoring trace components). Typical fuels may be any readily-available hydrocarbons such as natural gas, light distillates, methanol, propane, naphtha, kerosene, gasoline, jet fuel, diesel fuel, or combinations thereof. In a typical reforming process, gaseous hydrocarbon is percolated with oxygen in the form of air through a catalyst bed or beds contained within one or more reactor tubes mounted in a reformer vessel. The catalytic conversion process is typically carried out at elevated catalyst temperatures in the range of about 700° C. to about 1000° C.

The hydrogen-rich reformate stream may be used, for example, as the fuel gas stream feeding the anode of an electrochemical fuel cell. Reformate is particularly well suited to fueling a solid-oxide fuel cell (SOFC) system because a purification step for removal of carbon monoxide is not required as is the case for a proton exchange membrane (PEM) fuel cell system.

The reformate stream may also be used to fuel a spark-ignited (SI) engine, either alone or in combination with gasoline. Hydrogen-fueled vehicles are of interest as low-emissions vehicles because hydrogen as a fuel or a fuel additive can significantly reduce air pollution and can be produced from a variety of fuels. Hydrogen permits an engine to run with very lean fuel-air mixtures that greatly reduce production of NOx. As a gasoline additive, small supplemental amounts of hydrogen fuel may allow conventional gasoline-fueled internal combustion engines to reach nearly zero emissions levels.

Fuel/air mixture preparation constitutes a key factor in the reforming quality of catalytic reformers. A problem in the prior art has been how to vaporize an injected stream of liquid fuel completely and uniformly, especially at start-up when the apparatus is cold. Non-homogeneous fuel/air mixtures can lead to decreased reforming efficiency and reduced catalyst durability through coke or soot formation on the catalyst and thermal degradation from local hot spots. Poor fuel vaporization can lead to fuel puddling, resulting in uncertainty in the stoichiometry of the vaporized fuel mixture. Complete and rapid fuel vaporization is a key step to achieving a homogeneous gaseous fuel-air mixture having a constant fuel/air ratio.

Fuel vaporization is especially challenging under cold start and warm-up conditions for a fuel reformer. In the prior art, it is known to vaporize injected fuel by electrically preheating the incoming air stream (typically to about 150° C.) to be mixed with the fuel, or by electrically preheating a reformer surface for receiving a fuel spray. Problems arise from the long residence time (typically greater than about 20-30 milliseconds) of the fuel droplets within the vaporizer due to the low air temperature, which results in wall wetting as well as liquid penetration of the reformer catalyst face liquid fuel droplets. Because of non-homogeneous mixing in the mixing zone, uncontrolled pockets of fuel and air having about a stoichiometric combustion ratio can autoignite or flash back from the hot catalyst surface. The resulting uncontrolled combustion process upstream of the catalyst can lead to a significant decrease in performance of the reforming reactions as well as carbon and soot formation, which deactivates the catalyst. Carbon and hydrocarbon deposits are also known to form on the walls of the reactor, creating further sites for uncontrolled combustion.

What is needed is a method and apparatus for completely vaporizing liquid hydrocarbon fuel injected into a reformer assembly, even when the overall assembly is in a cold start-up condition.

It is a primary object of the invention to prevent coking of the housing and catalyst of a hydrocarbon reformer, especially at start-up of the reformer.

### SUMMARY OF THE INVENTION

A catalytic reformer assembly and methods of operation, including fast start-up, are provided. The reformer assembly provides reformate to an associated fuel cell stack assembly in known fashion. The reformer assembly includes a fuel vaporizer assembly comprising a combustion zone and a mixing zone ahead of the reformer catalyst bed. Liquid fuel flow to the vaporizer assembly is divided between a principal flow, which is sprayed into the mixing zone, and a smaller secondary flow (0-25%) that is directed to the combustion zone. Air flow is also divided between a principal flow to the mixing zone and a secondary flow to the combustor. The stoichiometry of the combustor has a fuel/air equivalence ratio of between about 0.65 and about 0.9 which prevents formation of solid carbon or soot while maintaining combustor wall temperatures within materials specifications when the secondary fuel/air mixture is ignited. The principal air flow is mixed with the combustor effluent together with fuel cell anode tailgas recycle (“recycle”) when it becomes available. The total flow of recycle may also be divided into a principal recycle flow and a secondary recycle flow. The mixture of combustion products, air, and recycle comprises a very small amount of molecular oxygen from the air and a large amount of water and carbon dioxide. By varying flows of the components, the mixture temperature can be controlled between about 200° C. and about 800° C., preferably between about 350° C. and about 650° C. The principal liquid fuel flow is then injected into the hot mixture of combustion products, air, and recycle in the mixing zone. Under these conditions, fuel evaporation time for the principal fuel flow is within about 2-5 milliseconds, whereas the time to evaporate the same droplets and spray in the prior art is much longer. This allows for a small, compact vaporizer that can be operated safely and without damage to the downstream catalytic converter.

### BRIEF DESCRIPTION OF THE DRAWINGS

The present invention will now be described, by way of example, with reference to the accompanying drawings, in which:

FIG. 1 is a schematic isometric view of a prior art hydrocarbon reformer including a vaporization and combustion chamber ahead of a catalyst bed;

FIG. 2 is a schematic diagram showing a first embodiment of a fuel vaporization assembly in accordance with the invention;

FIG. 3 is a schematic diagram showing a second embodiment of a fuel vaporization assembly in accordance with the invention;

FIG. 4 is a schematic diagram showing a third embodiment of a fuel vaporization assembly in accordance with the invention; and

FIG. 5 is a schematic diagram showing a fourth embodiment of a fuel vaporization assembly in accordance with the invention.

### DESCRIPTION OF THE PREFERRED EMBODIMENT

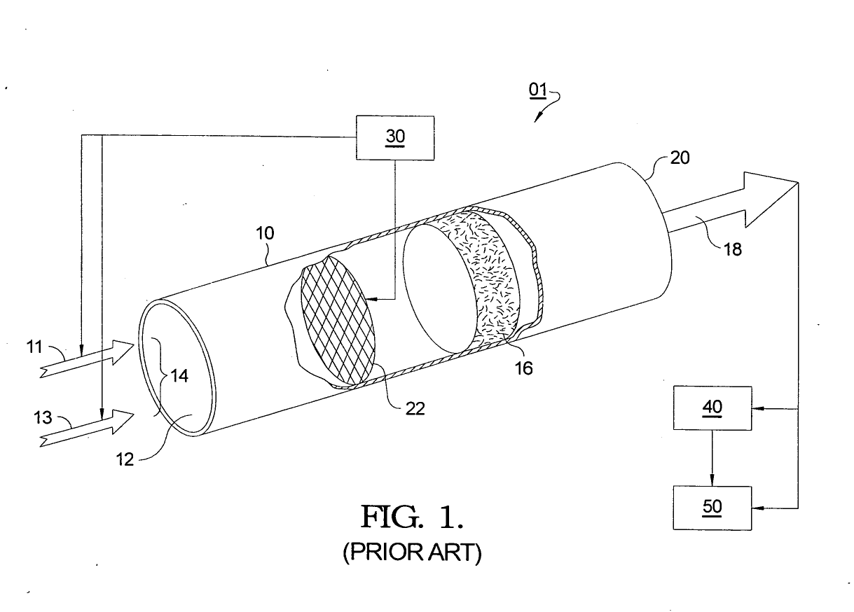

Referring to FIG. 1, a prior art fast light-off catalytic reformer assembly 01 includes a reactor 10 having an inlet 12 in a first end for receiving a flow of fuel 11 and a flow of air 13, shown as combined fuel-air mixture 14. Reactor 10 typically comprises a substantially cylindrical reactor tube. Reforming catalyst bed 16 is disposed within reactor 10. A protective coating or firewall (not shown) may be disposed about catalyst bed 16.

During operation, fuel-rich mixture 14 comprising air 13 and hydrocarbon fuel 11 such as natural gas, light distillates, methanol, propane, naphtha, kerosene, gasoline, jet fuel, diesel fuel, or combinations thereof, is converted by catalyst bed 16 to a hydrogen rich reformate fuel stream 18 that is discharged through outlet 20.

Ignition device 22 is disposed within reactor 10 to ignite fuel/air mixture 14 as desired. Heat generated by this reaction is used to provide fast light-off (i.e., rapid heating) of reforming catalyst 16 at start-up of the reformer. Ignition device 22 is disposed within the reactor 10 upstream of reforming catalyst 16, i.e., between inlet 12 and reforming catalyst 16. Ignition device 22 may be any device suitable for initiating exothermic reactions between fuel and air 14, including, but not limited to, a catalytic or non-catalytic substrate, such as a wire or gauze as shown in FIG. 1, for receiving electric current from a voltage source; a spark plug; a glow plug; or any combination thereof. An associated control system 30 selects and maintains the appropriate fuel and air delivery rates and operates the ignition device 22 so as to achieve fast light off of the reforming catalyst bed 16 at start-up and to maintain catalyst bed 16 at a temperature sufficient to optimize reformate 18 yield. At steady state reforming conditions, combustion by ignition device 22 is terminated.

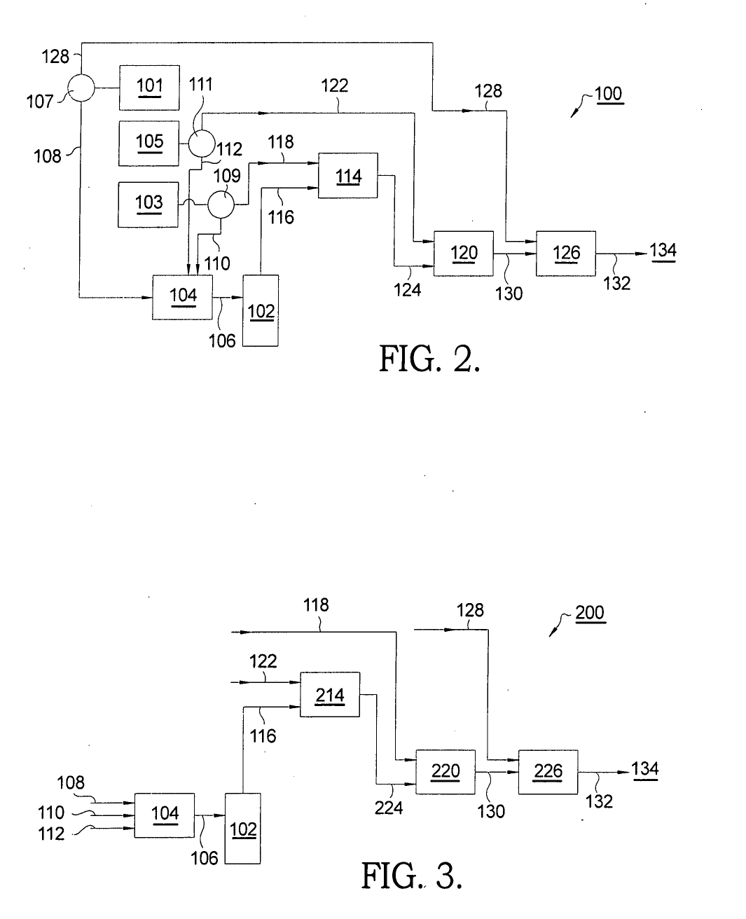

Referring now to FIG. 2, a first embodiment 100 of a liquid fuel vaporization system in accordance with the invention is especially useful for providing homogeneous mixtures of hydrocarbon fuels to a subsequent catalytic reformer (not shown) and fuel cell (also not shown), both of which are well known in the prior art and therefore need not be elaborated upon here. Anode tailgas (“recycle”) which is recycled from the anode outlet of the fuel cell is an important component and control element of the present system.

Embodiment 100 comprises a combustor zone 102 which includes igniter (not shown) for causing combustion; a first mixer 104 for supplying materials 106 for combustion in combustor zone 102; a source of fuel 101, air 103 and recycle 105 wherefrom fuel may be selectively divided between a primary fuel flow 128 and a secondary fuel flow 108 by control valve 107, air may be selectively divided between a primary air flow 118 and a secondary air flow 110 by control valve 109, and recycle may be selectively divided between a primary recycle flow 122 and a secondary recycle flow 112 by control valve 111; secondary fuel flow 108, secondary air flow 110, and secondary recycle flow 112 supplied to first mixer 104; a combustion dilution zone 114 for dilution of combustion products 116 with the principal air flow 118; a recycle mixing zone 120 for adding the principal recycle flow 122 to the diluted combustion products 124; and a main fuel mixing zone 126 for adding the principal fuel flow 128 to the recycle-diluted combustion products mixture 130 from zone 120 to yield a hot, homogeneous, fuel gas mixture 132 suitable for efficient reforming in a reformer catalyst bed 134.

Referring to FIG. 3, a second embodiment 200 is similar in most respects to first embodiment 100 except that the addition points of the principal air flow 118 and the principal recycle flow 122 are exchanged, wherein combustion products 116 are diluted with principal recycle flow 122 in combustion dilution zone 214, and diluted combustion products 224 are further diluted with principal air flow 118 in mixing zone 220 to yield the combustion products mixture 130.

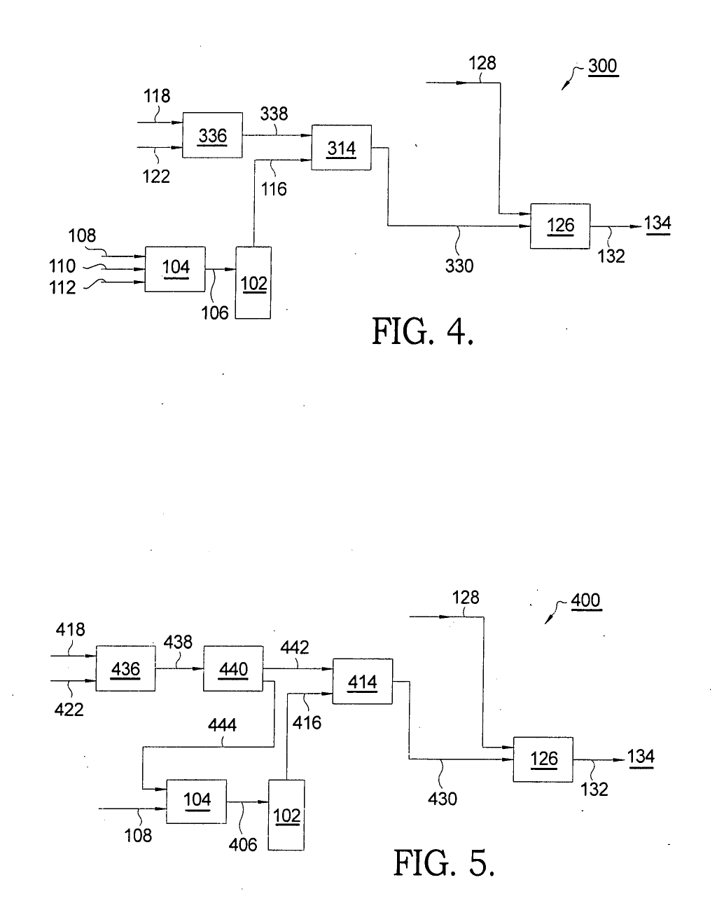

Referring to FIG. 4, a third embodiment 300 is similar to first and second embodiments 100,200 except that principal air flow 118 and principal recycle flow 122 are premixed in a mixing zone 336 and the air/recycle mixture 338 is used to dilute combustion products 116 in a single step in combustion dilution zone 314 (obviating the need for a separate recycle mixing zone 120,220 (FIGS. 2 and 3) at this point) to yield a fully diluted combustion products mixture 330 for addition to principal fuel flow 128 in main fuel mixing zone 126.

Referring now to FIG. 5, a fourth embodiment 400 is similar to first, second, and third embodiments 100,200,300 except that the entire air flow 418 and the entire recycle flow 422 are premixed in a mixing zone 436. The air/recycle mixture 438 is then divided by a split valve 440 into a principal flow 442 and a secondary flow 444. Secondary flow 444 is combined with secondary fuel flow 108 in mixer 104 to yield a mixture 406, which may or may not be identical with mixture 106, for combustion in combustion zone 102. Combustion product mixture 416 is combined with primary air/recycle flow 442 in mixing zone 414 to yield a mixture 430 identical with mixture 330 (FIG. 4) for combining with primary fuel flow 128 as in embodiment 300.

In operation in accordance with a method of the invention, during start-up from a cold start, no recycle is available, so lightoff is achieved by ignition in combustor 102 of a mixture of secondary fuel 108 and secondary air 110 only. Further, because no recycle is available, in ignition and start-up modes only dilution air is added downstream of combustor 102 and addition of principal fuel flow 128 is inhibited.

After combustion has proceeded for a few seconds, the secondary fuel and air flows may be gradually reduced as the system hardware becomes warmed by combustion product mixtures 116 or 416; however, in a presently preferred embodiment, some level of combustion is provided continuously during operation of the reformer and fuel cell. Recycle is added as described above when the fuel cell begins operation

The present fast light-off fuel vaporization system produces at least the following benefits over prior art vaporization systems and methods:

a) high yields of reformate fuel without significant coking or hot-spotting of the reactor or reforming catalyst during start-up;

b) simple ignition and startup without the necessity of electrical preheating of fuel and/or air;

c) virtually instantaneous evaporation of all spray droplets in mixing zone 126 due to high gas temperatures therein, before the droplets can travel to a wall or to the catalyst bed;

d) large amounts of water, CO₂, CO, and H₂ from the addition of anode gas recycle which bring benefit to vaporization due to changing vapor pressures and increasing the heat capacity and conductivity of the evaporating gas; and

e) provides molecular oxygen levels in mixing zone 126 in the range of about 5% to about 7%, much lower than the 20% level in pure air, thus preventing combustion under lean or rich fueling and all reforming conditions despite the relatively high temperatures.

While the invention has been described by reference to certain preferred embodiments, it should be understood that numerous changes may be made within the spirit and scope of the inventive concepts described. Accordingly, it is intended that the invention not be limited to the disclosed embodiments, but that it have the full scope permitted by the language of the following claims.

What is claimed is:

1. A method for vaporizing liquid hydrocarbon fuel and forming a gaseous mixture containing vaporized hydrocarbon fuel and air, comprising the steps of:
a) providing a total flow of fuel;
b) providing a total flow of air;
c) dividing said total flow of fuel into at least a principal flow and a secondary flow;
d) dividing said total flow of air into at least a principal flow and a secondary flow;
e) combining said secondary fuel flow and said secondary air flow to form a combustible mixture;
f) igniting said combustible mixture to form a mixture of hot combustion gases;
g) combining said principal air flow with said mixture of hot combustion gases to form a hot diluted mixture of combustion gases; and
h) combining said principal fuel flow with said mixture of hot diluted combustion gases to vaporize said principal fuel flow and form said gaseous mixture containing vaporized hydrocarbon fuel and air.

2. A method in accordance with claim 1 further comprising the steps of:
a) providing a total flow of recycle;
b) dividing said total flow of recycle into a principal flow and a secondary flow;
c) combining said secondary flow of recycle with said secondary fuel flow and said secondary air flow ahead of said igniting step, whereby said mixture of hot combustion gases includes said secondary recycle flow; and
d) adding said principal recycle flow ahead of said step of combining said principal fuel flow.

3. A method in accordance with claim 2 comprising the further step of combining said total air flow and said total recycle flow to form a mixture thereof, ahead of said step of dividing said total air flow into a principal flow and a secondary flow, and ahead of said step of dividing said total recycle flow into a principal flow and a secondary flow, such that said secondary air flow and said secondary recycle flow are mixed prior to being combined with said secondary fuel, and such that said principal air flow and said principal recycle flow are mixed prior to being combined with said mixture of hot combustion gases.

4. A method in accordance with claim 1 wherein said secondary fuel flow is in a range between about 0% and about 25% of said total fuel flow.

5. A method in accordance with claim 1 wherein the molecular oxygen content of said gaseous mixture containing vaporized hydrocarbon fuel and air is between about 5% and about 7%.

6. A catalytic hydrocarbon reformer assembly for generating reformate from a gaseous mixture containing vaporized hydrocarbon fuel and air, comprising:
a) a catalytic reforming bed; and
b) a vaporizer for vaporizing hydrocarbon fuel to form said gaseous mixture containing vaporized hydrocarbon fuel and air, said vaporizer including,
a source for providing a total flow of fuel,
a source for providing a total flow of air,
a valve for dividing said total flow of fuel into a principal flow and a secondary flow,
a valve for dividing said total flow of air into a principal flow and a secondary flow,
a first mixer for combining said secondary flow of fuel and said secondary air flow to form a combustible mixture,
a combustor for igniting said combustible mixture to form a mixture of hot combustion gases,
a second mixer for combining said principal air flow with said mixture of hot combustion gases to form a hot diluted mixture of combustion gases, and
a third for combining said principal fuel flow with said mixture of hot combustion gases to vaporize said principal fuel flow and form said gaseous mixture containing vaporized hydrocarbon fuel and air.

7. An assembly in accordance with claim 6 further including,
a source for providing a total flow of recycle,
a valve for dividing said total flow of recycle into a principal flow and a secondary flow wherein said first mixer further combines the secondary flow of recycle with said secondary flow of fuel and said secondary flow of air, and
a fourth mixer for combining said hot diluted mixture of combustion gases with said principal recycle flow to form a combustion products mixture, said combustion products mixture to be combined with the principal flow of fuel in said third mixer.
